(19) United States
(12) Patent Application Publication
(10) Pub. No.: US 2025/0292963 A1
(43) Pub. Date: Sep. 18, 2025

(54) MULTILAYER CERAMIC CAPACITOR

(71) Applicant: Murata Manufacturing Co., Ltd., Nagaokakyo-shi (JP)

(72) Inventors: Tsuyoshi NAKAGAWA, Nagaokakyo-shi (JP); Kenta HIRAI, Nagaokakyo-shi (JP)

(21) Appl. No.: 19/034,734

(22) Filed: Jan. 23, 2025

(30) Foreign Application Priority Data
Mar. 14, 2024 (JP) 2024-040335

(51) Int. Cl. H01G 4/232; H01G 4/008; H01G 4/012; H01G 4/12; H01G 4/30

(52) U.S. Cl. CPC H01G 4/232; H01G 4/008; H01G 4/012; H01G 4/1227; H01G 4/30

(57) ABSTRACT

In a multilayer ceramic capacitor, internal electrodes include counter portions opposed to adjacent internal electrodes in a lamination direction and first extension portions extending from the counter portions and each being connected to a corresponding one of a pair of external electrodes. A multilayer body includes an effective layer portion including the counter portions and portions of dielectric layers sandwiched by adjacent counter portions. The first extension portions each include a bent portion including an apex protruding in a direction toward a center in the lamination direction. A shortest distance in a length direction between the apex of the bent portion and the effective layer portion is larger than a dimension of a corresponding one of the dielectric layers, and is smaller than a shortest distance in the length direction between the apex of the bent portion and a corresponding one of first and second end surfaces.

### CROSS REFERENCE TO RELATED APPLICATIONS

This application claims the benefit of priority to Japanese Patent Application No. 2024-040335 filed on Mar. 14, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

In the related art, multilayer ceramic capacitors have been known as multilayer ceramic electronic components. In general, multilayer ceramic capacitors each include a multilayer body in which a plurality of dielectric layers and a plurality of internal electrode layers alternately are laminated, and external electrodes provided on both end surfaces of the multilayer body. For example, Japanese Unexamined Patent Application, Publication No. 2001-237137 discloses a multilayer ceramic capacitor including the above-described configuration and further including external electrodes each including a base electrode layer provided by firing.

However, in the general multilayer ceramic capacitor disclosed in Japanese Unexamined Patent Application, Publication No. 2001-237137, voids (gaps) are likely to be formed in the vicinity of the end portions of the internal electrode layers. If voids exist in these portions, a crack may occur starting from the voids. Therefore, there is room for improvement in terms of reliability.

### SUMMARY OF THE INVENTION

Example embodiments of the present invention provide multilayer ceramic capacitors that are each able to reduce or prevent the generation of voids.

An example embodiment of the present invention provides a multilayer ceramic capacitor that includes a multilayer body including an inner layer portion including a plurality of dielectric layers and a plurality of internal electrodes that are alternately laminated, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction, and a pair of external electrodes, one of the pair of external electrodes being provided on the first end surface and another one being provided on the second end surface. The plurality of internal electrodes include counter portions opposed to adjacent internal electrodes in the lamination direction and extension portions extending from the counter portion and each being connected to a corresponding one of the pair of external electrodes. The multilayer body includes an effective layer portion including the counter portions of the plurality of internal electrodes and portions of the plurality of dielectric layers which are sandwiched by adjacent counter portions of the plurality of internal electrodes. When, in the lamination direction, a direction from each of the first main surface and the second main surface toward a middle portion of the multilayer body in the lamination direction is defined as a direction toward a center in the lamination direction, the extension portions each include a bent portion including an apex protruding in the direction toward the center in the lamination direction. A shortest distance in the length direction between the apex of the bent portion and the effective layer portion is larger than a dimension of a corresponding one of the plurality of dielectric layers in the lamination direction, and is smaller than a shortest distance in the length direction between the apex of the bent portion and a corresponding one of the first end surface or the second end surface.

According to example embodiments of the present invention, it is possible to provide multilayer ceramic capacitors that are each able to reduce or prevent the generation of voids.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view taken along the line II-II of FIG. 1.

FIG. 3 is a cross-sectional view taken along the line II-II of FIG. 1.

### DETAILED DESCRIPTION OF THE EXAMPLE EMBODIMENTS

Example embodiments of the present invention will be described in detail below with reference to the drawings.

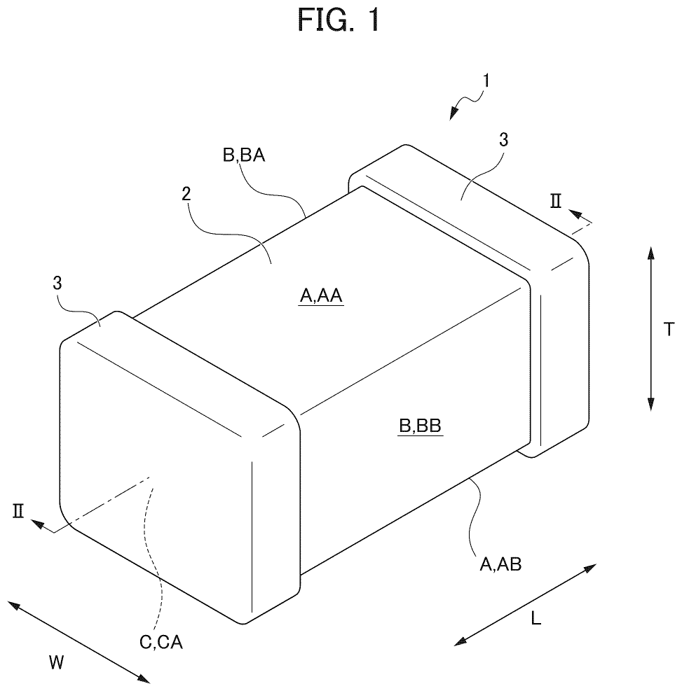

Hereinafter, a multilayer ceramic capacitor 1 according to an example embodiment of the present invention will be described with reference to FIGS. 1 to 3.

### Multilayer Ceramic Capacitor 1

As shown in FIG. 1, the multilayer ceramic capacitor 1 is a multilayer ceramic capacitor including a two-terminal configuration. The multilayer ceramic capacitor 1 includes a multilayer body 2 and a pair of external electrodes 3. The multilayer body 2 has a rectangular or substantially rectangular parallelepiped shape and includes six outer surfaces. The multilayer body 2 includes an inner layer portion 11 in which dielectric layers 14 and internal electrodes 15 are laminated.

In the present specification, a direction in which the dielectric layers 14 and the internal electrodes 15 are laminated in the multilayer ceramic capacitor 1 is referred to as a lamination (stacking) direction T. One of the directions orthogonal or substantially orthogonal to the lamination direction T is defined as a length direction L. A direction orthogonal or substantially orthogonal to the length direction L and the lamination direction T is defined as a width direction W. In the lamination direction T, a direction from a middle portion of the multilayer body 2 in the lamination direction T toward each main surface A is referred to as a “direction T1 toward the outer side in the lamination direction”. In the lamination direction T, a direction from each main surface A toward a middle portion of the multilayer body 2 in the lamination direction T is referred to as a “direction T2 toward the center in the lamination direction”.

Among the six outer surfaces of the multilayer body 2, a pair of outer surfaces provided on both sides in the lamination direction T is defined as a first main surface AA and a second main surface AB, a pair of outer surfaces extending in the lamination direction T and provided on both sides in the width direction W is defined as a first lateral surface BA and a second lateral surface BB, and a pair of outer surfaces extending in the lamination direction T and provided on both sides in the length direction L is defined as a first end surface CA and a second end surface CB. The first main surface AA and the second main surface AB may be collectively referred to as “main surfaces A”. The first lateral surface BA and the second lateral surface BB may be collectively referred to as “each lateral surfaces B”. The first end surface CA and the second end surface CB may be collectively referred to as “each end surface C”.

Each of the pair of external electrodes 3 is provided on end surface C. The external electrodes 3 are arranged in the length direction L.

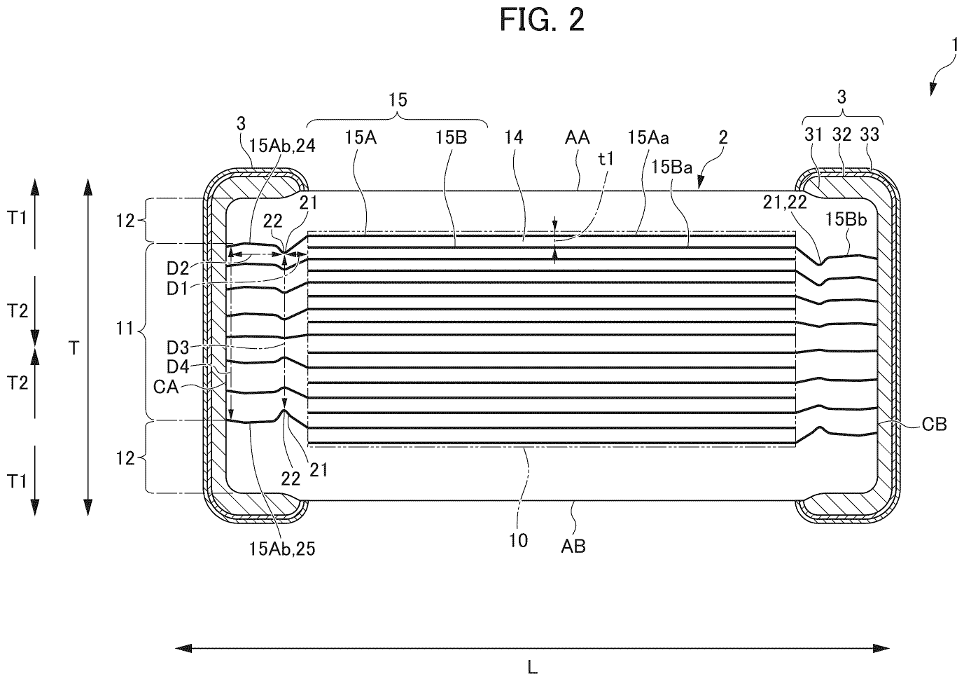

A cross section parallel or substantially parallel to the lamination direction T and the length direction L is referred to as an “LT cross section”. The cross section of FIG. 2 is a cross section passing through the middle portion in the width direction W of the multilayer ceramic capacitor 1.

### Multilayer Body 2

The multilayer body 2 includes an inner layer portion 11 and a pair of outer layer portions 12 sandwiching the inner layer portion 11 in the lamination direction T. The multilayer body 2 preferably includes rounded corner portions and rounded ridge portions. Each of the corner portions refers to a portion where three surfaces of the multilayer body intersect with each other. Each of the ridge portions refers to a portion where two surfaces of the multilayer body intersect with each other.

### Inner Layer Portion 11

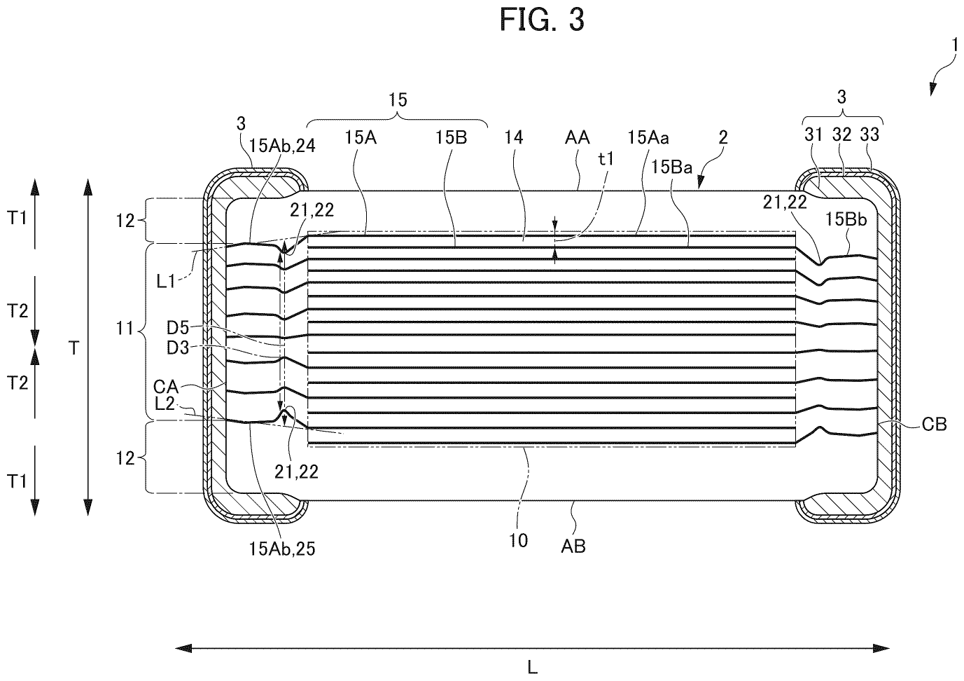

As shown in FIGS. 2 and 3, the inner layer portion 11 includes a plurality of dielectric layers 14 and a plurality of internal electrodes 15. The dielectric layers 14 and the internal electrodes 15 are alternately laminated.

Each of the dielectric layers 14 is made of, for example, a dielectric ceramic including BaTiO₃ as a main component. The dielectric ceramic may include, for example, a Mn compound, a Fe compound, a Cr compound, a Co compound, a Ni compound, or the like as a subcomponent.

Each of the internal electrodes 15 are made of a metal material such as, for example, Ni, Cu, Ag, Pd, an Ag—Pd alloy, or Au. The internal electrodes 15 include a plurality of first internal electrodes 15A and a plurality of second internal electrodes 15B. Each of the first internal electrodes 15A is exposed only at the first end surface CA. Each of the second internal electrodes 15B is exposed only at the second end surface CB. The first internal electrodes 15A and the second internal electrodes 15B are alternately provided. Among the internal electrodes 15, one closest to the first main surface AA is the first internal electrode 15A. Among the internal electrodes 15, one closest to the second main surface AB is the second internal electrode 15B.

Each of the first internal electrodes 15A includes a first counter portion 15Aa and a first extension portion 15Ab. The first counter portion 15Aa is a portion of the first internal electrode 15A and is opposed to the second internal electrode 15B adjacent to each other in the lamination direction T. The first counter portion 15Aa is located at a middle portion between the end surfaces C. The first extension portion 15Ab is a portion of the first internal electrode 15A that extends from the first counter portion 15Aa toward the first end surface CA. The first extension portion 15Ab is exposed at the first end surface CA. The first extension portion 15Ab is connected to the external electrode 3.

Each of the second internal electrodes 15B includes a second counter portion 15Ba and a second extension portion 15Bb. The second counter portion 15Ba is a portion of the second internal electrode 15B and is opposed to the first internal electrode 15A (first counter portion 15Aa) adjacent to each other. The second counter portion 15Ba is located at the middle portion between the end surfaces C. The second extension portion 15Bb is a portion of the second internal electrode 15B and extends from the second counter portion 15Ba toward the second end surface CB. The second extension portion 15Bb is exposed at the second end surface CB. The second extension portion 15Bb is connected to the external electrode 3.

The first internal electrodes 15A and the second internal electrodes 15B may be collectively referred to as “internal electrodes 15”. The first counter portion 15Aa and the second counter portion 15Ba may be collectively referred to as “counter portion 15a”.

In addition, the multilayer body 2 includes an effective layer portion 10 including each counter portion 15a and dielectric layers 14 sandwiched between the adjacent counter portions 15a. The effective layer portion 10 is a portion where a capacitance of the multilayer ceramic capacitor 1 is generated.

### Outer Layer Portion 12

Each of the outer layer portions 12 is made of the same material as the dielectric layer 14 of the inner layer portion 11. The internal electrode 15 is not provided in the outer layer portion 12.

### External Electrode 3

The external electrodes 3 are respectively provided on the end surfaces C. Each of the external electrodes 3 covers not only the end surface C, but also a portion of the main surface A and a portion of the lateral surface B. Each of the external electrodes 3 includes a base electrode layer 31 provided in contact with the surface of the multilayer body 2, a first plated layer 32 provided on the base electrode layer 31, and a second plated layer 33 provided on the first plated layer 32.

The base electrode layer 31 is, for example, a fired layer including an electrically conductive metal such as Cu (copper) and glass. One of the first internal electrode 15A or the second internal electrode 15B is connected to the base electrode layer 31. The first plated layer 32 is, for example, a Ni (nickel) plated layer. The second plated layer 33 is, for example, a Sn (tin) plated layer.

The multilayer ceramic capacitor 1 has a symmetrical or substantially symmetrical structure in the length direction L. Therefore, in the following description, a region adjacent to the first end surface CA will be described as an example.

Here, each of the first extension portions 15Ab includes a bent portion 21 that includes an apex 22 protruding in the direction T2 toward the center in the lamination direction. In other words, the first extension portion 15Ab is bent at the bent portion 21 to protrude in the direction T2 toward the center in the lamination direction.

The shortest distance (referred to as “D1”) in the length direction L between the apex 22 of the bent portion 21 and the effective layer portion 10 is larger than the dimension (referred to as “t1”) in the lamination direction T of the dielectric layer 14, and is smaller than the shortest distance (referred to as “D2”) in the length direction L between the apex 22 of the bent portion 21 and a corresponding one of the end surfaces C adjacent to the apex 22 (specifically, the first end surface CA).

The dimension in the lamination direction T of the dielectric layer 14 is defined as the dimension in the lamination direction T of the dielectric layer 14 which is adjacent to the internal electrode 15 as a measurement target for D1 or D2 in the direction T2 toward the center in the lamination direction.

The apex 22 of the bent portion 21 of the first internal electrode 15A is preferably located, for example, more in the direction T2 toward the center in the lamination direction than a portion defining and functioning as the effective layer portion 10 of the dielectric layer 14, which is adjacent to the first internal electrode 15A. In other words, the bent portion 21 of the first internal electrode 15A preferably covers entirely or substantially entirely in the lamination direction T the portion defining and functioning as the effective layer portion 10 of the dielectric layer 14, which is adjacent to the first internal electrode 15A. However, the bent portion 21 of the first internal electrode 15A may not necessarily cover entirely or substantially entirely in the lamination direction T the portion defining and functioning as the effective layer portion 10 of the dielectric layer 14, which is adjacent to the first internal electrode 15A.

D1 is, for example, about 50 μm or less.

Among the first extension portions 15Ab, the first extension portion 15Ab located closest to the first main surface AA is defined as a “first main surface-side outermost first extension portion 24”. Among the first extension portions 15Ab, the first extension portion 15Ab located closest to the second main surface AB is defined as a “second main surface-side outermost first extension portion 25”. The first main surface-side outermost first extension portion 24 includes a bent portion 21. The second main surface-side outermost first extension portion 25 includes a bent portion 21.

The length (referred to as “D3”) of a line segment connecting between the apex 22 of the bent portion 21 of the first main surface-side outermost first extension portion 24 and the apex 22 of the bent portion 21 of the second main surface-side outermost first extension portion 25 is smaller than the length (referred to as “D4”) of a line segment connecting between an end portion of the first main surface-side outermost first extension portion 24 adjacent to the first end surface CA and an end portion of the second main surface-side outermost first extension portion 25 adjacent to the first end surface CA. In FIG. 2, D4 is shown at a position slightly deviated from the actual position for convenience of illustration.

In addition, D4 is smaller than the dimension in the lamination direction T of the effective layer portion 10. Each of the end portions of the first extension portions 15Ab adjacent to the first end surface CA is bent in the direction T2 toward the center in the lamination direction.

A virtual straight line that passes through the end portion of the first main surface-side outermost first extension portion 24 adjacent to the first end surface CA and is in contact with the first counter portion 15Aa of the first internal electrode 15A including the first main surface-side outermost first extension portion 24 is defined as a “first virtual line L1” (see FIG. 3). A virtual straight line that passes through the end portion of the second main surface-side outermost first extension portion 25 adjacent to the first end surface CA and is in contact with the first counter portion 15Aa of the first internal electrode 15A including the second main surface-side outermost first extension portion 25 is defined as a “second virtual line L2”.

The length (“D5”) of a virtual line segment that connects the first virtual line L1 and the second virtual line L2 and passes through the apex 22 of the bent portion 21 of the first main surface-side outermost first extension portion 24 and the apex 22 of the bent portion 21 of the second main surface-side outermost first extension portion 25 is larger than D3. In addition, in FIG. 3, an arrow indicating D3 and an arrow indicating D5 are shown shifted from each other for convenience of illustration.

In this case, as compared with a case where D5 is equal to or less than D3, it is possible to reduce the interval between the adjacent apexes 22. This makes it possible to reduce or prevent the generation of voids in the vicinity of the end portions of the internal electrodes 15.

As a case where D5 is equal to or less than D3, for example, a case can be considered where the first main surface-side outermost first extension portion 24 is bent to protrude in the direction T2 toward the center in the lamination direction and the second main surface-side outermost first extension portion 25 is bent to protrude in the direction T1 toward the outer side in the lamination direction.

In addition, a region near the first end surface CA of each main surface A is bent in the direction T2 toward the center in the lamination direction. The step portion of each main surface A that provides the bend coincides or substantially coincides in the length direction L with the position of the bent portion 21 of the internal electrode 15.

### Measurement Method

Next, an example of a method of measuring each value will be described. First, the multilayer body 2 is polished to expose a predetermined cross section in the middle of the LT cross section passing through the width direction W of the multilayer body 2. Next, the exposed cross section is observed with a scanning electron microscope, and various dimensions or distances are measured.

When the dimension in the lamination direction T of the dielectric layer 14 is measured, the dimension in the lamination direction T of the dielectric layer 14 is measured at the middle portion in the length direction L of the portion defining and functioning as the effective layer portion 10 of the dielectric layer 14. The obtained value is defined as the dimension in the lamination direction T of the dielectric layer 14.

### Manufacturing Method of Multilayer Ceramic Capacitor 1

Next, an example of a method of manufacturing the multilayer ceramic capacitor 1 of the present example embodiment will be described. The manufacturing method of the multilayer ceramic capacitor 1 of the present example embodiment is not limited as long as the requirements described above are satisfied. However, a preferred manufacturing method includes the following steps. The details of each step will be described below.

A dielectric sheet for manufacturing the dielectric layer 14 and an electrically conductive paste for manufacturing the internal electrode 15 are prepared. The dielectric sheet and the electrically conductive paste for manufacturing the internal electrode include a binder and a solvent. The binder and the solvent may be known.

An electrically conductive paste for manufacturing the internal electrodes 15 is printed on the dielectric sheet in a predetermined pattern by, for example, screen printing or gravure printing. Thus, the dielectric sheet on which the pattern of the first internal electrodes 15A is formed and the dielectric sheet on which the pattern of the second internal electrodes 15B is formed are prepared.

A portion defining and functioning as the outer layer portion 12 adjacent to the first main surface AA is formed by laminating a predetermined number of dielectric sheets on which the internal electrode pattern is not printed. Dielectric sheets on which the pattern of the first internal electrodes 15A is printed and dielectric sheets on which the pattern of the second internal electrodes 15B is printed are sequentially laminated thereon, such that a portion defining and functioning as the inner layer portion 11 is formed. A predetermined number of dielectric sheets on which no internal electrode pattern is printed are laminated on the portion defining and functioning as the inner layer portion 11, such that a portion defining and functioning as the outer layer portion 12 on the second main surface AB side is formed. This produces a multilayer sheet.

The multilayer sheet is pressed in the lamination direction by, for example, isostatic pressing or the like, such that a multilayer block is produced. At this time, each surface of the multilayer sheet in the lamination direction T is covered with a rubber sheet material (referred to as “rubber”). Then, an elongated round rod-shaped member (referred to as a “push rod”) is provided over the rubber at a desired position on each surface of the multilayer sheet in the lamination direction T. In that state, the multilayer sheet is pressed with the rubber and each push rod. This allows the push rod to press into the multilayer sheet, so that an electrically conductive paste for manufacturing the internal electrode can be bent in the direction T2 toward the center in the lamination direction.

The configuration of the bending of the electrically conductive paste for manufacturing internal electrodes can be adjusted, for example, by adjusting the thickness and flexibility of the rubber. For example, first pressing is performed using a thick rubber, and second pressing is performed using a rubber thinner than the first rubber. By performing pressing in multiple steps in this way, the multilayer sheet can be pressed while being deformed, and the configuration of the bending of the electrically conductive paste for manufacturing internal electrodes can be adjusted. When the push rod is pushed into the multilayer sheet, pressure is applied to the dielectric sheet. As a result, bubbles in the dielectric sheet can be removed, such that it is possible to reduce or prevent the generation of voids in the dielectric layer.

Next, the multilayer block is cut in each of the length direction L and the width direction W. The multilayer block is cut into a predetermined size to produce multilayer chips. At this time, corner portions and ridge portions of each of the multilayer chips may be rounded by, for example, barrel polishing or the like.

Each of the multilayer chips is fired to produce the multilayer body 2. The firing temperature is, for example, preferably about 900° C. or more and about 1400° C. or less depending on the materials of the dielectric layer 14 and the internal electrode 15.

An electrically conductive paste for the base electrode layer 31 is applied to both end surfaces of the multilayer body 2. In the present example embodiment, the base electrode layer 31 is, for example, a fired layer. An electrically conductive paste including a glass component and a metal is applied to the multilayer body 2 by a method such as dipping, for example. Thereafter, a firing process is performed to form the base electrode layer 31. The temperature of the firing processing at this time is, for example, preferably about 700° C. or more and about 950° C. or less.

In the present example embodiment, dipping is performed so that the base electrode layer 31 on the first end surface CA extends from the first end surface CA to a portion of the first main surface AA and a portion of the second main surface AB. Further, dipping is performed so that the base electrode layer 31 on the second end surface CB extends from the second end surface CB to a portion of the first main surface AA and a portion of the second main surface AB. At the same time, dipping is preferably performed so that the base electrode layer on the first end surface CA extends to a portion of the first lateral surface BA and a portion of the second lateral surface BB. Further, the dipping is preferably performed so that the base electrode layer 31 on the second end surface CB extends to a portion of the first lateral surface BA and a portion of the second lateral surface BB.

In addition, the multilayer chip before firing and the electrically conductive paste applied to the multilayer chip may be fired at the same time. In this case, the fired layer is preferably formed by firing a material to which a ceramic material has been added, instead of a glass component. At this time, as the ceramic material to be added, it is particularly preferable to use the same type of ceramic material as the dielectric layer 14. In this case, an electrically conductive paste is applied to each of the multilayer chips before firing, and the multilayer chip and the electrically conductive paste applied to the multilayer chip are simultaneously fired to form the multilayer body 2 in which the fired layer is formed.

Thereafter, a plated layer is formed on the surface of the base electrode layer 31. In the present example embodiment, for example, the Ni plated layer and the Sn plated layer are formed on the base electrode layer. The Ni plated layer and the Sn plated layer are sequentially formed by, for example, electroplating. As a plating method, for example, barrel plating is preferably used.

Thus, the multilayer ceramic capacitor 1 shown in FIG. 1 is obtained.

### Advantageous Effects of Example Embodiment

According to the present example embodiment, the following advantageous effects can be obtained.

According to the present example embodiment, the first extension portion 15Ab includes the bent portion 21 that includes the apex 22 protruding in the direction T2 toward the center in the lamination direction. The shortest distance in the length direction L between the apex 22 of the bent portion 21 and the effective layer portion 10 is larger than the dimension in the lamination direction T of the dielectric layer 14, and is smaller than the shortest distance in the length direction L between the apex 22 of the bent portion 21 and a corresponding one of the end surfaces C adjacent to the apex 22 (specifically, the first end surface CA).

Since the vicinity of the boundary portion between the counter portion and the extension portion of each of the internal electrodes 15 in the multilayer body 2 is a region where the lamination number of the multilayer body changes, voids are likely to occur in the vicinity of the boundary portion in the length direction L, particularly in the vicinity of the end portion of the internal electrode 15. When voids are present in this portion, electrostrictive cracks and moisture resistance defects tend to occur starting from the voids. By providing the configuration of the present example embodiment, it is possible to reduce or prevent the generation of voids that cause electrostrictive cracks and poor moisture resistance. That is, the present example embodiment includes a configuration that allows the extension portion to be pressed to form a bent portion. This makes it possible for the voids to be removed, thus reducing or preventing the generation of the voids.

According to the present example embodiment, the shortest distance in the length direction L between the apex 22 of the bent portion 21 and the effective layer portion 10 is, for example, about 50 μm or less.

According to such a configuration, it is possible for the voids to be removed more efficiently, and it is possible to further improve the electrostriction resistance and the moisture resistance.

According to the present example embodiment, the first main surface-side outermost first extension portion 24 includes the bent portion 21. The second main surface-side outermost first extension portion 25 includes the bent portion 21. The length of a line segment connecting between the apex 22 of the bent portion 21 of the first main surface-side outermost first extension portion 24 and the apex 22 of the bent portion 21 of the second main surface-side outermost first extension portion 25 is smaller than the length of a line segment connecting between the end portion of the first main surface-side outermost first extension portion 24 adjacent to the first end surface CA and the end portion of the second main surface-side outermost first extension portion 25 adjacent to the first end surface CA.

According to such a configuration, it is possible for the voids to be removed more efficiently, and it is possible to further improve the electrostriction resistance and the moisture resistance.

Although example embodiments of the present invention have been described above, the present invention is not limited to the above-described example embodiments, and various changes and modifications can be made.

In the above-described example embodiments, the apex of the bent portion 21 of the internal electrode 15 is located, for example, more in the direction T2 toward the center in the lamination direction than the portion functioning as the effective layer portion 10 of the dielectric layer 14, which is adjacent to the internal electrode 15. However, the apex of the bent portion 21 of the internal electrode 15 may be aligned in the length direction L with the portion defining and functioning as the effective layer portion 10 of the dielectric layer 14, which is adjacent to the first internal electrode 15. However, the configuration of the above-described example embodiment is preferable in that a desired advantageous effect can be more reliably obtained in the multilayer ceramic capacitor 1.

In the above-described example embodiments, the configuration of the multilayer ceramic capacitor 1 includes a symmetrical or substantially symmetrical structure in the length direction L. However, it is not to be limited thereto. The second extension portion 15Bb may or may not include a configuration corresponding to the bent portion 21 of the first extension portion 15Ab. However, the configuration of the above-described example embodiment is preferable in that a desired advantageous effect can be more reliably obtained in the multilayer ceramic capacitor 1.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of dielectric layers and a plurality of internal electrodes that are alternately laminated, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction; and
a pair of external electrodes; wherein
one of the pair of external electrodes is on the first end surface and another one is on the second end surface;
the plurality of internal electrodes include counter portions each opposed to adjacent internal electrodes in the lamination direction and extension portions each extending from the counter portions and being connected to a corresponding one of the pair of external electrodes;
the multilayer body includes an effective layer portion including the counter portions of the plurality of internal electrodes and portions of the plurality of dielectric layers sandwiched by adjacent counter portions of the plurality of internal electrodes;
in the lamination direction, a direction from each of the first main surface and the second main surface toward a middle portion of the multilayer body in the lamination direction is defined as a direction toward a center in the lamination direction;
the extension portions each include a bent portion including an apex protruding in the direction toward the center in the lamination direction; and
a shortest distance in the length direction between the apex of the bent portion and the effective layer portion is larger than a dimension of a corresponding one of the plurality of dielectric layers in the lamination direction, and is smaller than a shortest distance in the length direction between the apex of the bent portion and a corresponding one of the first end surface or the second end surface.

2. The multilayer ceramic capacitor according to claim 1, wherein the shortest distance in the length direction between the apex of the bent portion and the effective layer portion is about 50 μm or less.

3. The multilayer ceramic capacitor according to claim 1, wherein
the extension portions that extend from the counter portions and are exposed at the first end surface are defined as first extension portions;
among the first extension portions, one located closest to the first main surface is defined as a first main surface-side outermost first extension portion;
among the first extension portions, one located closest to the second main surface-side is defined as a second main surface-side outermost first extension portion;
a length of a line segment connecting between the apex of the bent portion of the first main surface-side outermost first extension portion and the apex of the bent portion of the second main surface-side outermost first extension portion is smaller than a length of a line segment connecting between an end portion of the first main surface-side outermost first extension portion adjacent to the first end surface and an end surface of the second main surface-side outermost first extension portion adjacent to the first end surface.

4. The multilayer ceramic capacitor according to claim 1, wherein the multilayer body includes a pair of outer layer portions sandwiching the inner layer portion in the lamination direction.

5. The multilayer ceramic capacitor according to claim 4, wherein each of the pair of outer layer portions includes a same material as each of the plurality of dielectric layers.

6. The multilayer ceramic capacitor according to claim 1, wherein each of the plurality of dielectric layers includes BaTiO₃ as a main component.

7. The multilayer ceramic capacitor according to claim 6, wherein each of the plurality of dielectric layers includes a Mn compound, a Fe compound, a Cr compound, a Co compound, or a Ni compound as a subcomponent.

8. The multilayer ceramic capacitor according to claim 1, wherein each of the plurality of internal electrode layers includes Ni, Cu, Ag, Pd, an Ag—Pd alloy, or Au.

9. The multilayer ceramic capacitor according to claim 1, wherein each of the pair of external electrodes extends to portions of first and second main surfaces and portions of the first and second lateral surfaces.

10. The multilayer ceramic capacitor according to claim 1, wherein each of the pair of external electrodes includes a base electrode layer, a first plated layer on the base electrode layer, and a second plated layer on the first plated layer.

11. The multilayer ceramic capacitor according to claim 10, wherein the base electrode layer is a fired layer including metal and glass.

12. The multilayer ceramic capacitor according to claim 11, wherein the metal includes Cu.

13. The multilayer ceramic capacitor according to claim 10, wherein the first plated layer includes Ni and the second plated layer includes Sn.
